(19) United States
(12) Patent Application Publication
(10) Pub. No.: US 2022/0194517 A1
(43) Pub. Date: Jun. 23, 2022

(54) CONTROL SYSTEM FOR ELECTRIC BICYCLE

(71) Applicant: Matthew David Nelson, San Clemente, CA (US)

(72) Inventor: Matthew David Nelson, San Clemente, CA (US)

(21) Appl. No.: 17/644,959

(22) Filed: Dec. 17, 2021

Related U.S. Application Data
(60) Provisional application No. 63/127,557, filed on Dec. 18, 2020.

(51) Int. Cl. B62M 6/45; B62M 6/55; B62M 9/122; B62M 9/132; B62K 23/06

(52) U.S. Cl. CPC B62M 6/45; B62M 6/55; B62K 23/06; B62M 9/132; B62M 9/122

(57) ABSTRACT

Disclosed is a method for controlling power supplied to an electric drive system of an electric bicycle. The method includes determining a pedal assist power level for the electric drive system, determining a first current to be applied to the electric drive system based on the pedal assist power level, detecting a user selected boost assist at a first input while the first current is being applied to the electric drive system, and determining a second current to be applied to the electric drive system based at least in part on both the user selected boost assist and a boost trigger, the boost trigger being received via a second input.

### CROSS-REFERENCE TO RELATED APPLICATION

This application claims benefit under 35 U.S.C. 119(e) to U.S. Provisional Patent App. No. 63/127,557, filed Dec. 18, 2020, the entire disclosure of which is hereby incorporated by reference herein in its entirety. Any and all priority claims identified in the Application Data Sheet, or any corrections thereto, are hereby incorporated by reference under 37 CFR 1.57.

### BACKGROUND

### Field

The present disclosure generally relates to motor-assisted, manually powered bicycles. More specifically, aspects of this disclosure relate to adaptive pedal assist systems, control logic, derailleurs, and battery systems for motorized bicycles.

### Description of the Related Art

Different types of pedal assisted bicycles are known. One type utilizes a chain and an electric motor to assist pedaling. The power required to move the bicycle is supplied to the driving wheel at the same time by the user and by the electric motor via the chain.

The electric motor generally propels the bicycle in either an unassisted or an assisted capacity, i.e., with or without manually generated motive power. For instance, an electric bicycle can be equipped with an on-board battery and electric motor for providing supplemental tractive torque that assists a user's pedal-generated torque. The electric motor operates alone or in conjunction with a transmission to rotate a driven member of the electric bicycle, such as a chain, wheel, wheel hub, or crank. Output torque from the electric motor may be selectively delivered to the driven member, e.g., when the user applies pedal force and/or rotates the driven member. In this manner, the user's perceived pedaling effort may be reduced when riding the electric bicycle relative to the perceived pedaling effort on a conventional bicycle lacking an electrical assist function.

### SUMMARY

In one aspect, a method for controlling power supplied to an electric drive system of an electric bicycle. The method includes determining a pedal assist power level for the electric drive system, determining a first current to be applied to the electric drive system based on the pedal assist power level, detecting a user selected boost assist at a first input while the first current is being applied to the electric drive system, and determining a second current to be applied to the electric drive system based at least in part on both the user selected boost assist and a boost trigger, the boost trigger being received via a second input.

In another aspect, a control system for controlling power supplied to an electric motor of an electric bicycle is disclosed. The control system includes a first input configured to receive a user selected boost assist for an electric drive system, a second input configured to receive a boost trigger for the electric drive system, an electric motor, and a controller. The controller configured to determine a first current to be applied to the electric motor based on a pedal assist power level and determine a second current to be applied to the electric motor based at least in part on both the user selected boost assist and the boost trigger.

### BRIEF DESCRIPTION OF THE DRAWINGS

The features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will now be described with additional specificity and detail through use of the accompanying drawings.

FIGS. 1 and 2 are side elevational views of a bicycle that is equipped with a bicycle control apparatus in accordance with a preferred embodiment of the present invention;

FIGS. 3 and 4 are enlarged side elevational views of a transmission having a rear derailleur of the bicycle from FIG. 1;

FIG. 5A is a side elevational view of a prior art transmission having a rear derailleur in a prior art location;

FIG. 5B is a side elevational view similar to FIG. 5A except the rear derailleur has been moved to a wrapped location relative to the rear sprockets;

FIG. 5C is a side elevational view similar to FIG. 5A and shows another rear derailleur in a prior art location;

FIG. 5D is a side elevational view similar to FIG. 5C except the rear derailleur has been moved to a wrapped location relative to the rear sprockets;

FIG. 6 is a perspective view showing a boost assist selector input attached to a handlebar unit of the bicycle from FIG. 1;

FIG. 7 is a perspective view showing a boost trigger attached to the handlebar unit of the bicycle from FIG. 1;

FIGS. 8 through 13 are views of a crank and electric motor of the bicycle from FIG. 1;

FIGS. 14A, 14B, 15A, and 15B are views of a remote battery system housing a rechargeable battery for powering, for example, the electric motor;

FIG. 16 is a schematic view of the bicycle control apparatus in accordance with a preferred embodiment of the present invention; and

FIG. 17 is a flowchart showing exemplary control operations executed by the controller for controlling the electric motor.

### DETAILED DESCRIPTION

The following detailed description is directed to certain specific embodiments. The invention(s) disclosed herein, however, can be embodied in a multitude of different ways as defined and covered by the claims.

In this description, reference is made to the drawings, wherein like parts are designated with like numerals throughout. The features, aspects and advantages of the present invention will now be described with reference to the drawings of several embodiments that are intended to be within the scope of the article herein disclosed. These and other embodiments will become readily apparent to those skilled in the art from the following detailed description of the embodiments having reference to the attached figures, the invention not being limited to any particular embodiment(s) herein disclosed.

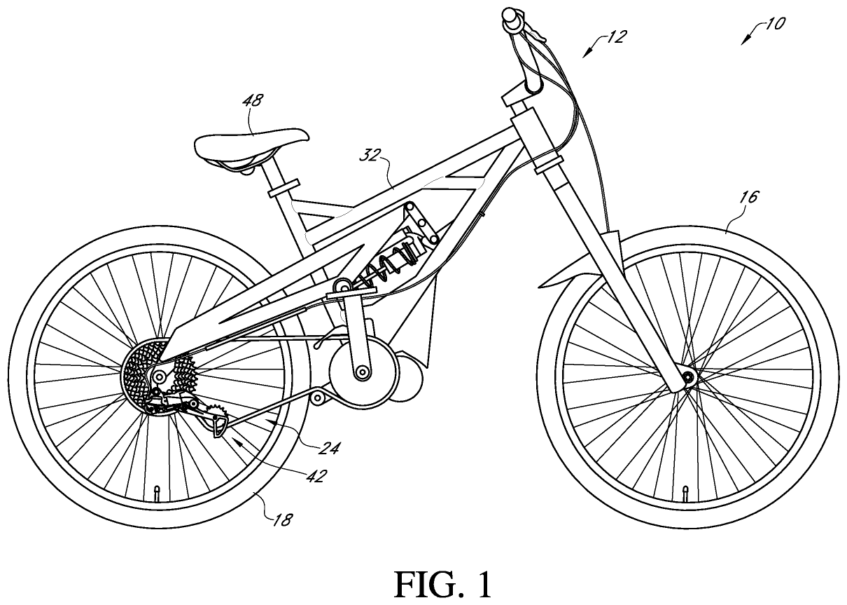

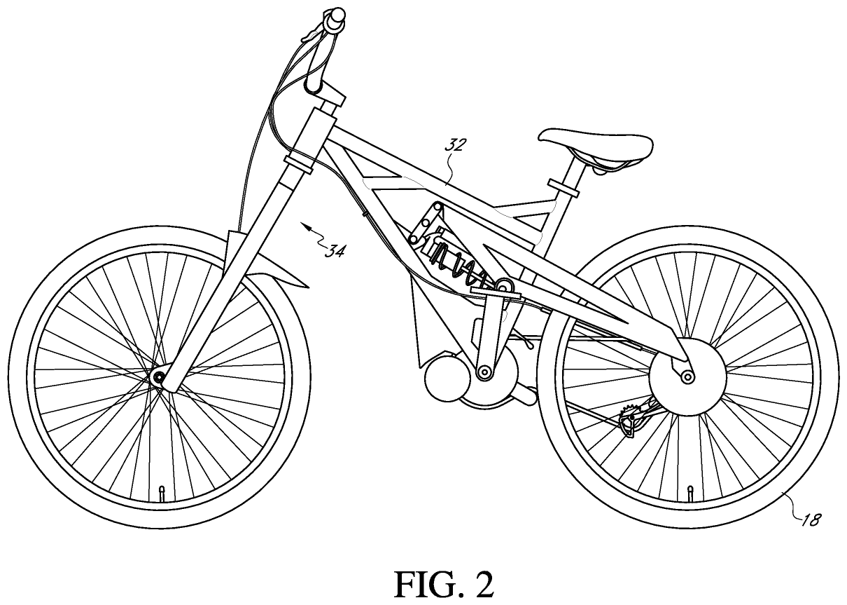

FIGS. 1 and 2 are side elevational views of a bicycle 10 that is equipped with a bicycle control apparatus in accordance with a preferred embodiment of the present invention. In certain embodiments, the bicycle 10 comprises a frame 12, a handlebar unit 14, a front wheel 16, a rear wheel 18, a chain 20, a crank 22, and a transmission 24. In the illustrated embodiment, the transmission 24 comprises a rear derailleur 42.

In certain embodiments, the bicycle 10 further comprises an electric motor 28 and a controller 30 for generating an assistance drive force. The chain 20, the crank 22, the controller 30, the transmission 24, and the electric motor 28 are parts of a drive system or driveline of the bicycle 10 for propelling the bicycle 10.

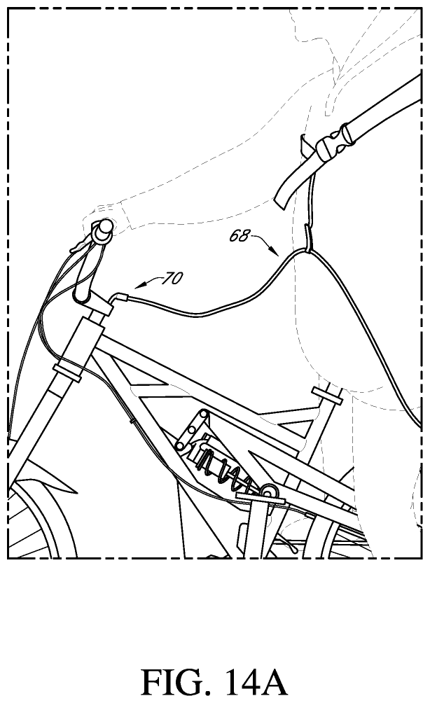

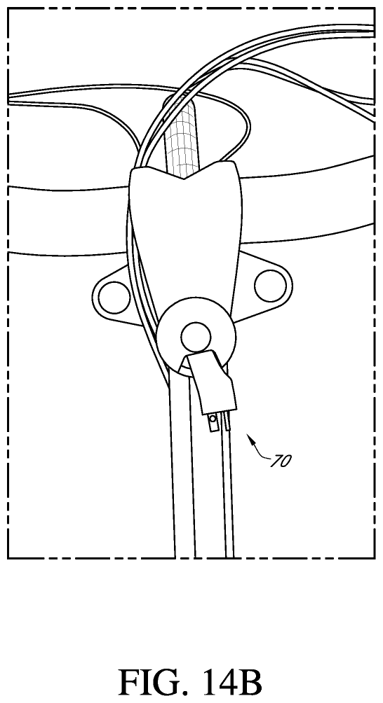

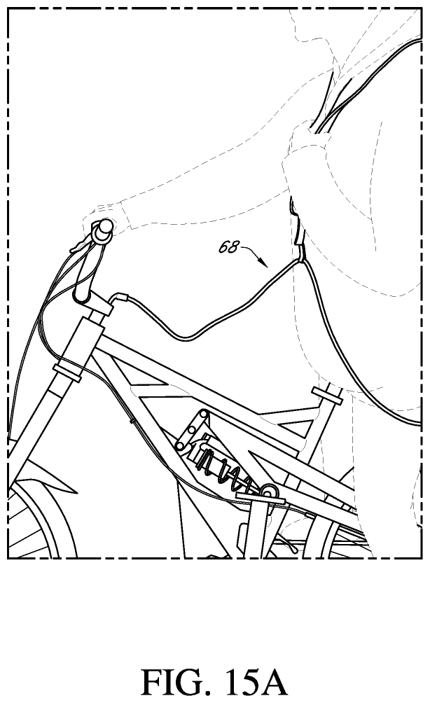

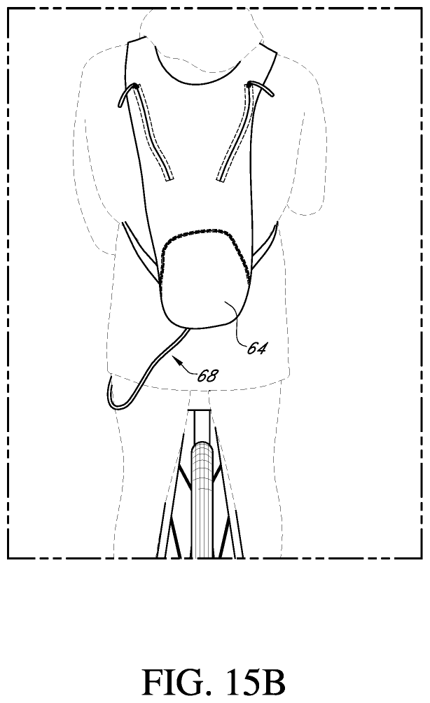

A rechargeable battery (not shown) for powering the electric motor 28 can be attached to or carried separately from the bicycle 10. For example, the rechargeable battery 26 can be attached to the down tube of the bicycle 10. In other embodiments where the rechargeable battery (not shown) is not attached to the bicycle 10, the user can carry the rechargeable battery (not shown). For example, the user can place the rechargeable battery (not shown) in a fanny pack or backpack (see FIGS. 14A, 14B, 15A, and 15B).

In certain embodiments, the frame 12 has a frame body 32 and a front fork 34. In certain embodiments, the front fork 34 is attached to a frontward portion of the frame body 32 such that it can pivot about a slanted axis. A seat 48, the handlebar unit 14, and other components are attached to the frame body 32.

In certain embodiments, the crank 22 comprises a crank axle 50 and a left-right pair of crank arms 52 and 54 that are provided on axially opposite ends of the crank axle 50. In the illustrated embodiment, the left-right pair of crank arms 52 and 54 are arranged 180 degrees out of phase from each other. In certain embodiments, the crank axle 50 is rotatably supported in a hanger section 56 of the frame body 32. Pedals 58 are attached to the free ends of the left and right crank arms 52 and 54. In certain embodiments, the chain 20 is arranged on a front sprocket 66 fixed to the left and right crank arms 52 and 54 and a rear sprocket 60 provided on the transmission 24.

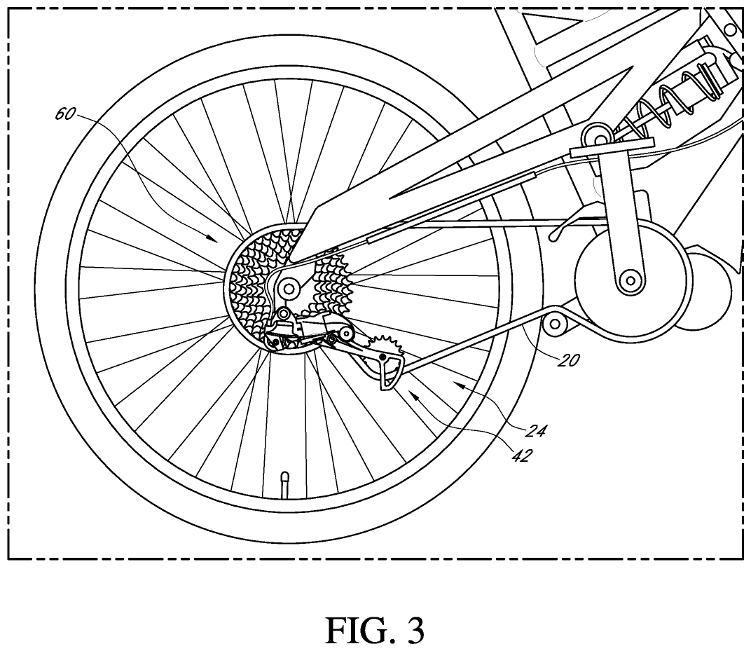

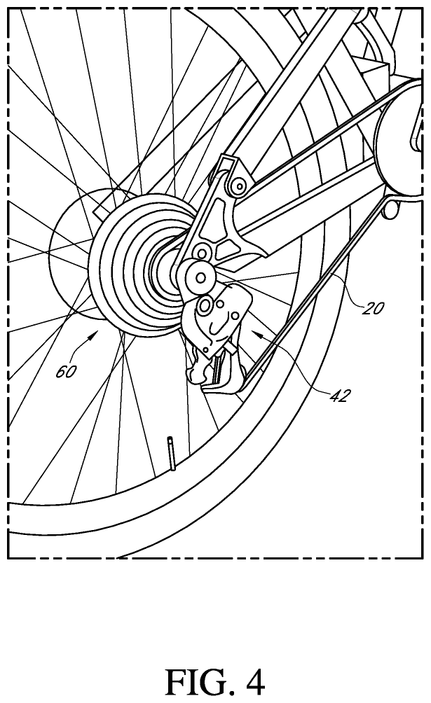

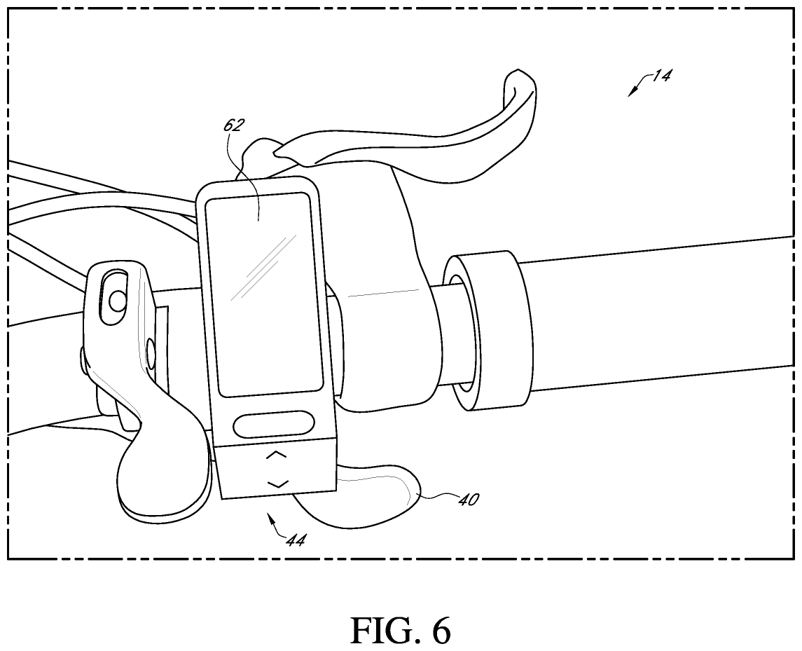

As shown in FIGS. 3 and 4, in certain embodiments, the transmission 24 is a cable driven transmission connected to a gear shifter 40 shown in FIG. 6. In certain embodiments, the gear shifter 40 can be mounted on the handlebar unit 14 with shift cables. In certain embodiments, the gear shifter 40 is arranged, for example, on the handlebar unit 14 adjacent to the front brake lever on the inward side of a portion where the front brake lever is attached. In certain other embodiments, the transmission 24 is electrically driven.

In certain embodiments, the transmission 24 comprises one or more derailleurs 42. In certain embodiments, the transmission 24 comprises only one derailleur 42 disposed at the rear of the bicycle 10. In certain embodiments, the one or more derailleurs 42 comprises front and rear derailleurs 42. The derailleur 42 is a gear changing mechanism. In certain embodiments, the gear shifter 40 is coupled to the derailleur 42 and serves to drive the gear changing mechanism. For example, in certain embodiments, the derailleur 42 serves to place the chain 20 onto any one of a plurality of (e.g., ten) rear sprockets 60 having different diameters. In this way, the rear sprockets 60 are driven by the chain 20 and arranged at a center portion of the rear wheel 18. In certain embodiments that include a front derailleur 42, the front derailleur 42 serves to place the chain 20 onto any one of a plurality of (e.g., three) front sprockets 66 having different diameters.

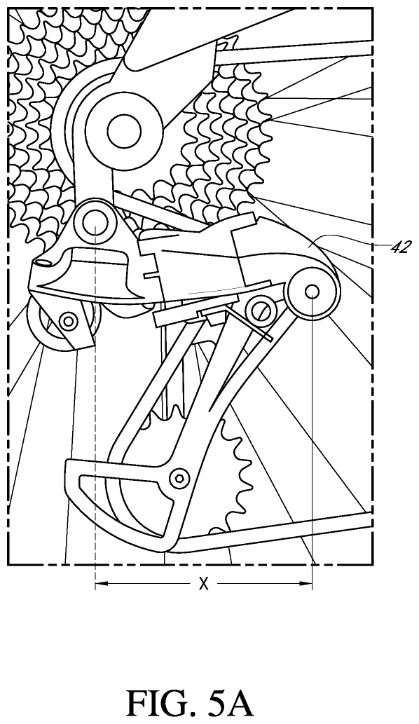

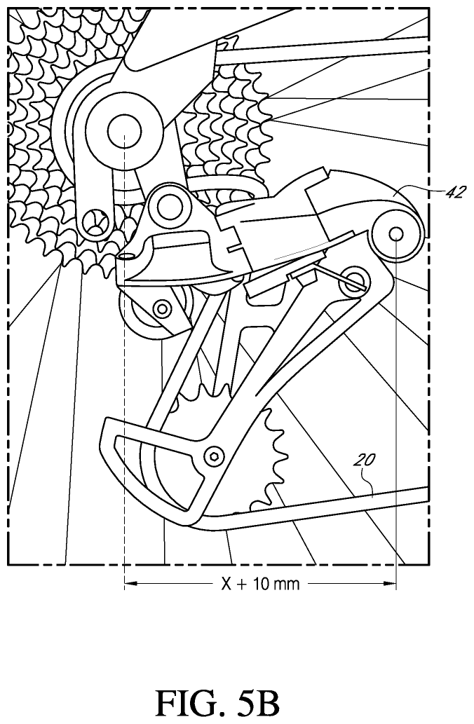

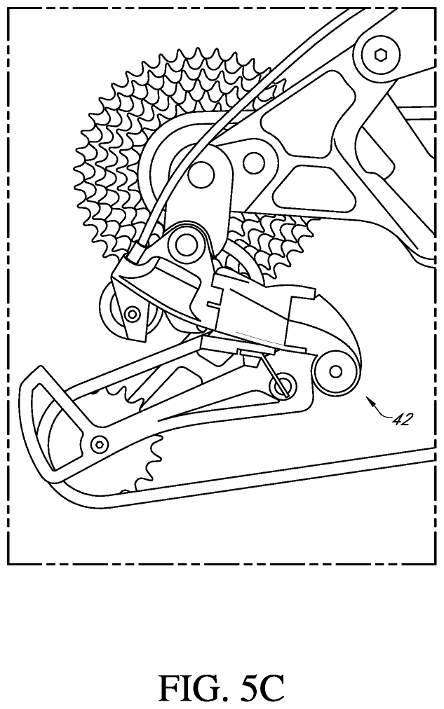

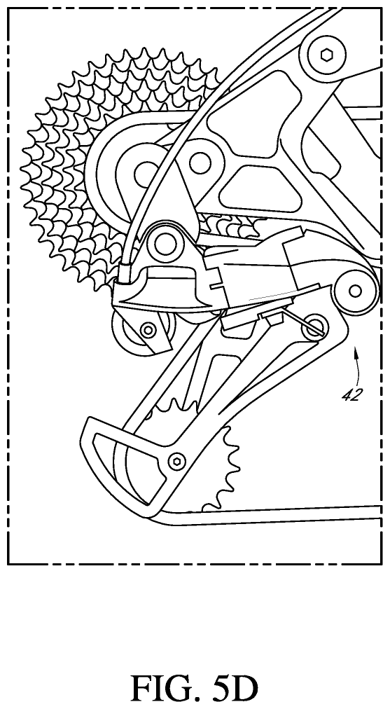

FIG. 5A is a side elevational view of a prior art transmission having a rear derailleur 42 for comparison to the derailleur 42 shown in FIG. 5B. FIG. 5B is a side elevational view similar to FIG. 5A except the rear derailleur has been moved to a wrapped location relative to the rear sprockets 60. As shown, the derailleur 42 in FIG. 5B is shifted forward relative to the rear sprockets 60 in a direction towards the front wheel 16 as compared to the derailleur illustrated in FIG. 5A. In certain embodiments, the derailleur 42 is shifted 10 mm forward relative to the rear sprockets 60 when compared to the spacing between the prior art derailleur and the prior art rear sprockets. In other embodiments, the derailleur 42 is shifted more or less than 10 mm relative to the rear sprockets 60. For example, in certain embodiments, the derailleur 42 is shifted forward 15 mm relative to the rear sprockets 60. In certain embodiments, the derailleur 42 is shifted forward 5 mm relative to the rear sprockets 60. In certain embodiments, the derailleur 42 is shifted forward and upward relative to the rear sprockets 60.

FIG. 5C is side elevational view similar to FIG. 5A and shows another rear derailleur 42 in a prior art location. FIG. 5D is a side elevational view similar to FIG. 5C except the rear derailleur 42 has been moved to a wrapped location relative to the rear sprockets. The derailleur 42 in the wrapped location has been further wrapped about the circumference of the rear sprockets 60 as compared to the prior art location. For example, in certain prior art embodiments, the derailleur 42 is located at a 7:30 location (i.e., 225 degrees) on a clock face superimposed over the rear sprockets 60. In certain embodiments, the derailleur 42 in the prior art embodiment has been wrapped in a counterclockwise direction about the rear sprockets 60 to a 4:30-5:00 (i.e., 135-150 degrees) location when moving to the wrapped location. Of course, the disclosure is not limited to the listed dimensions and contemplates any change in the location of the prior art rear derailleur 42 that results in the rear derailleur 42 wrapping further about the circumference of the rear sprockets 60. The rear derailleur 42 is fixed in the wrapped location as is known by a person having ordinary skill in the art. In certain embodiments, the frame has an elevated chain stay to facilitate wrapping of the derailleur 42 about the rear sprockets 60.

Shifting the derailleur 42 forward relative to the rear sprocket 60 increases the length of the chain 20 in contact with the rear sprocket 60. In this way, the chain 20 wraps further around the outer circumference of the rear sprocket 60. When tension is applied to the chain 20 wrapped around the outer circumference of the rear sprocket 60, the length of engagement between the chain 20 and the sprocket 60 increases with the amount of wrap about the rear sprocket 60. The increase in the amount of wrap reduces the tension being applied by the chain 20 to individual teeth of the rear sprocket 60. In certain embodiments, this reduction in tension reduces the likelihood of a chain failure 20 which increases the reliability of the transmission 24.

FIG. 6 is a perspective view showing a boost assist selector input 44 attached to the handlebar unit 14. In certain embodiments, the boost assist selector input 44 can be a single unit integrating a first operating button and a second operating button. The first and second operating buttons are positioned such that a person can operate them by hand while gripping the grip. In certain embodiments, the first and second operating buttons are pushbuttons or toggle switches. In certain embodiments, the first operating button is a button for increasing a boost assist level from a lower level to a higher level. In certain embodiments, the lowest level is off and the highest level is 9. As explained below, in certain embodiments, the off position turns off both a pedal assist and the boost assist. In certain embodiments, the second operating button is below the first operating button for decreasing a boost assist level from a higher level to a lower level. In other embodiments, the boost assist selector input 44 is a single lever or toggle which increases a boost assist level from a lower level to a higher level when activated in an up direction and decreases the boost assist level from a higher level to a lower level when activated in a down direction. The boost assist selector input 44 sends a signal that changes according to its position within its range of motion to the controller 30. The boost assist selector input 44 can be realized with, for example, a potentiometer. In certain embodiments, the boost assist selector input 44 also has an off mode in which it does not provide assistance.

In certain embodiments, a display device 62 is fixed to the handlebar unit 14. In certain embodiments, the display device 62 has a liquid crystal display screen and serves to display such information as the current boost assist level.

The gear shifter 40 is further shown in FIG. 6 below the boost assist selector input 44. The gear shifter 40 is arranged, for example, on the handlebar unit 14 adjacent to the rear brake lever on the inward side of a portion where the rear brake lever is attached. In certain embodiments, the gear shifter 40 can be a single unit integrating a first operating lever and a second operating lever. The first and second operating levers are positioned such that a person can operate them by hand while gripping the grip. In certain embodiments, the first operating lever is a lever for actuating the transmission 24 causing the derailleur 42 to move the chain 20 to a sprocket 60 that has a smaller diameter. In certain embodiments, the second operating lever is a lever for actuating the transmission 24 causing the derailleur 42 to move the chain 20 to a sprocket 60 that has a larger diameter. In this way, the transmission 24 can be shifted to any desired sprocket 60 by operating the gear shifter 40.

In certain embodiments, the handlebar unit 14 has a handlebar stem fixed to an upper portion of the front fork 34 and a handlebar that is fixed to the handlebar stem. A brake lever and a grip are attached to each of both ends of the handlebar unit 14.

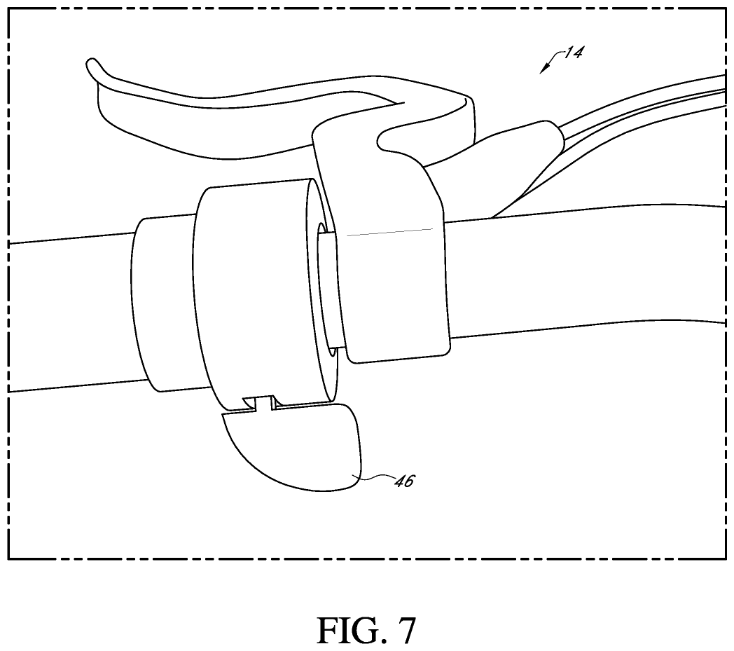

FIG. 7 is a perspective view showing a boost trigger 46 attached to a handlebar unit 14. In certain embodiments, the boost trigger 46 comprises an operating button. The operating button is positioned such that a person can operate it by hand while gripping the grip. In certain embodiments, the boost trigger 46 is a pushbutton or toggle switch. In certain embodiments, the boost trigger 46 is biased to return to an off position when released by the user.

In certain embodiments, the boost trigger 46 is configured to override the pedal assist level and increase an assist level from the current pedal assist level to a boosted assist level. In certain embodiments, the boost trigger 46 is coupled to the controller 30. In certain embodiments, the boost trigger 46 is mechanically coupled to the controller 30. In certain embodiments, the boost trigger 46 is electrically coupled to the controller 30. In certain embodiments, the boost trigger 46 sends an on/off signal that changes the assist level from the pedal assist level to the boost assist level. In certain embodiments, the boost trigger 46 sends a signal that changes according to its position within its range of motion to the controller 30. The boost trigger 46 can be realized with, for example, a potentiometer.

The amount of boost and the rate at which the boost is added to the driveline can alter the feel of the bicycle 10 and how it handles. In embodiments where the signal from the boost trigger 46 changes according to its position within its range of motion, the user can rapidly move the boost trigger 46 to a maximum value to quickly increase the boost assist to a high value. It may be advantageous depending on, for example, the terrain to instead gradually increase the boost from a low value to the maximum value. For example, when the user is exiting a turn in loose dirt and immediately applies maximum boost in the hopes of increasing exit speed, the abrupt increase in torque to the rear wheel 18 may cause the rear wheel 18 to lose traction while also increasing steering difficulty. An abrupt increase in torque to the rear wheel 18 can shift weight off the front wheel 16 changing steering dynamics and front wheel 16 traction.

In certain embodiments, allowing the user to gradually add torque to the rear wheel 18 via the boost trigger 46 while exiting a turn, for example, will maximize exit speed from the turn without changing handling dynamics. In certain embodiments where the boost trigger 46 is biased to return to an off position when not activated, the user can increase and decrease the amount of torque added to the rear wheel 18 by modulating the amount of pressure they apply to the boost trigger 46.

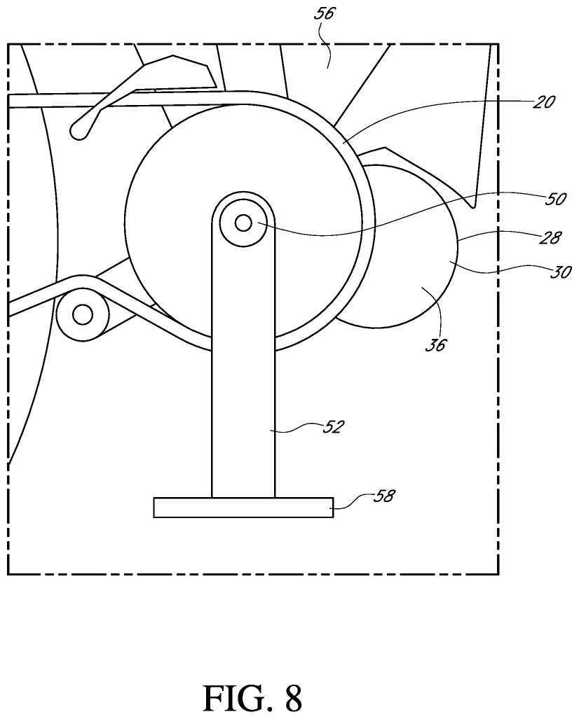

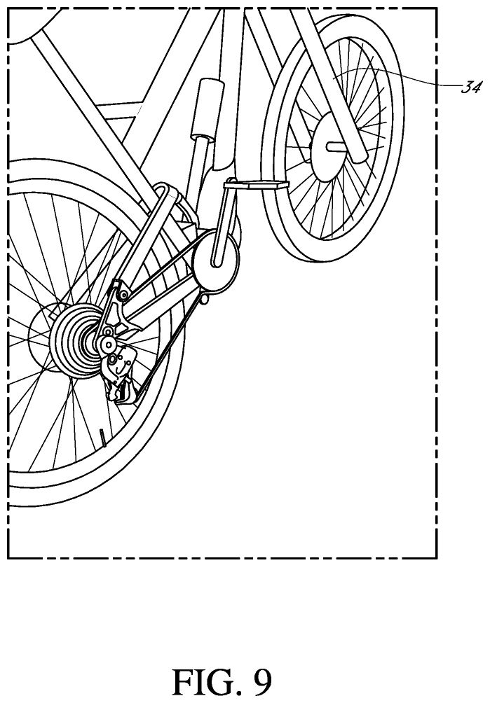

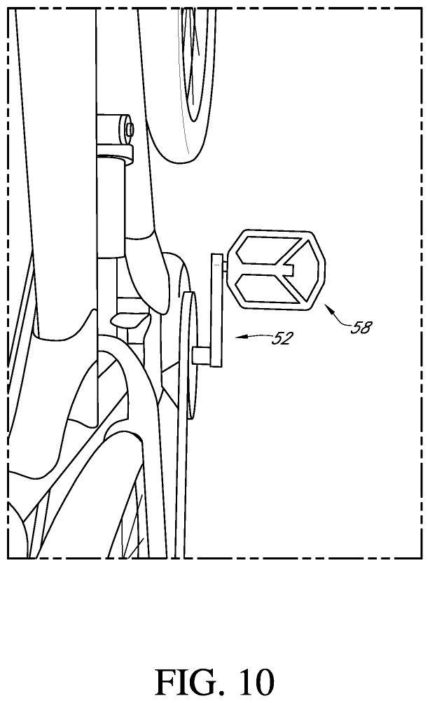

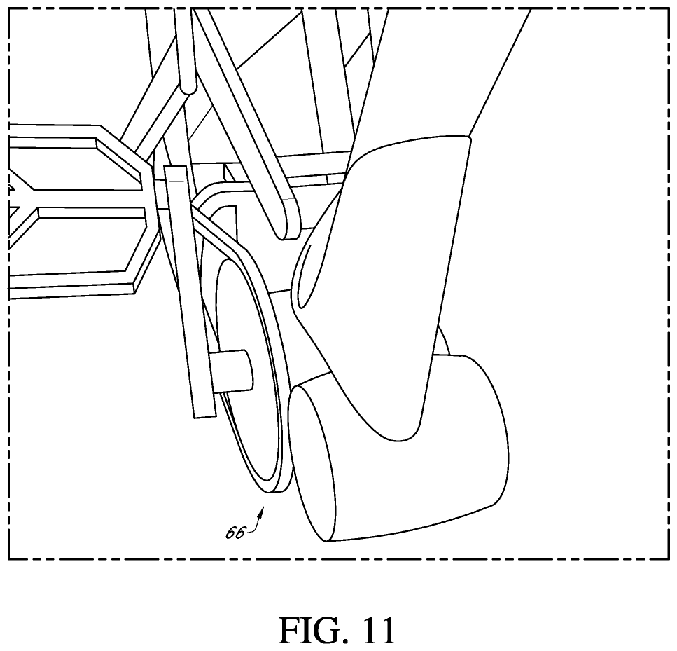

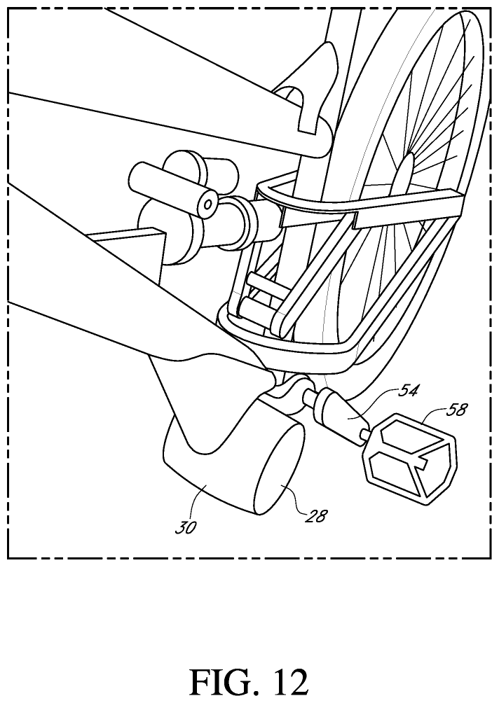

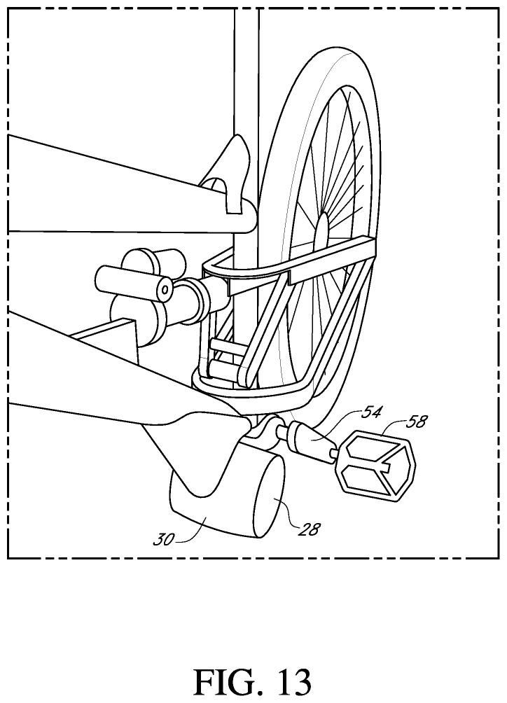

FIGS. 8 through 13 are views of a crank 22 and electric motor 28. In certain embodiments, the electric motor 28 is coupled to the crank 22 and serves to generate an assistance drive force for driving the driveline. In certain embodiments, the electric motor 28 is attached to a center portion of the frame body 32 and serves to apply the assistance drive force to the crank 22 for driving the chain 20. In certain embodiments, the electric motor 28 is attached to the down tube in the region of the hanger section 56. As shown in FIG. 11 through 13, the controller 30 and the electric motor 28 can be located within the same housing. In certain embodiment, the housing is the electric motor housing. In certain embodiments, the electric motor 28 is, for example, a brushless DC motor or an AC motor. In certain embodiments, an inverter converts a direct current outputted from the rechargeable battery (not shown) into an alternating current suitable for driving the electric motor 28. In certain embodiments, the controller 30 is preprogramed for the electric motor 28 to provide a fixed level of pedal assist when the boost assist is off. For example, the level of pedal assist can be preprogramed to be one of levels S, M, or L.

In certain embodiments, the controller 30 determines the preprogrammed level by accessing a stored value. In other embodiments, the user can select the level of the pedal assist. In certain embodiments, the controller 30 determines the preprogrammed level based at least in part on one or more characteristics of the user (e.g., weight, endurance level, etc.). In certain embodiments, the user provides the characteristics directly to the controller 30 via a user interface. In certain embodiments, the user provides the characteristics via an application such as a phone app. In certain embodiments, the application wirelessly connects (Bluetooth, cellular, WI-FI, etc.) to the controller 30.

In certain embodiments, the bicycle 10 includes a speed sensor or rotation sensor 36 for detecting whether the crank 22 is rotating about the crank axle 50. In certain embodiments, the electric motor 28 provides the preprogrammed level of pedal assist when the crank 22 is rotating. In certain embodiments, the speed sensor or rotation sensor 36 determines the speed of the bicycle 10. In certain embodiments, the rotation sensor 36 detects a rotating magnet. For example, in certain embodiments, the rotation sensor 36 is disposed at a base end of the left or right cranks 52, 54 as shown in FIG. 8. The rotation sensor 36 employs, for example, a Hall element, a Reed switch or another magnetic force detecting member. In certain embodiments, the rotation sensor 36 is fixed to the hanger section 56 in such a position that it can face across from the magnet. In certain embodiments, the controller 30 controls the electric motor 28 to not provide an assistance drive force when the traveling speed of the bicycle 10 is below a predetermined speed.

In certain embodiments, the bicycle 10 includes a torque sensor (not shown) for detecting the level of pedaling force being applied by the user. In certain embodiments, the torque sensor (not shown) is attached to the hanger section 56 of the frame body 32. In certain embodiments, the torque sensor (not shown) detects a torque of the crank axle 50 in a non-contact manner or by contacting the crank axle 50 or the right or left crank arms 52, 54. In certain embodiments, the torque sensor (not shown) is, for example, a magnetostrictive sensor having a magnetostrictive element provided on the crank axle 50 and a detection coil arranged facing opposite the magnetostrictive element. In other embodiments, the torque sensor (not shown) is, for example, a strain gauge provided on the crank axle 50 or the right or left crank arms 52, 54. In other embodiments, the strain gauge is provided on a supporting portion supporting the crank axle 50. The torque sensor (not shown) is not limited to these configurations and any sensor whose output varies according to the torque acting on the crank axle 50 is acceptable. In certain embodiments, the torque sensor (not shown) sends a signal that changes according to the pedaling force acting on the crank axle 50 to the controller 30.

In certain embodiments, the torque corresponding to the pedaling force of the user is, for example, a torque equal to the product of the force applied to the pedal and a prescribed value. In certain embodiments, the prescribed value is a distance between an axis of the pedal 58 and the crank axle 50. The pedaling force resulting when the user depresses the pedal 58 is detected by the torque sensor (not shown).

In certain embodiments, the controller 30 is disposed inside a housing as explained above. In certain embodiments, the controller 30 receives information from one or more sensors and commands resulting from operations performed by the user. The controller 30 controls the output of the electric motor 28. In certain embodiments, the controller 30 is preprogrammed with a level of pedal assist and is electrically connected to one or more of the rotation sensor 36, the setting of the boost assist selector input 44, and the setting of the boost trigger 46. In certain embodiments, the controller 30 is electrically connected to the torque sensor (not shown).

In certain embodiments, the controller 30 can include a microcomputer, and serves to control electrical components to which it is electrically connected. In certain embodiments, the controller 30 includes a processor or CPU (central processing unit), a RAM (random access memory), a ROM (read only memory), and an I/O interface. In certain embodiments, the ROM can include a mathematical relationship between one or more of: the user's pedaling force; the setting of the boost assist selector input 44; the preprogrammed level of the pedal assist, and the setting of the boost trigger 46. In this way and in certain embodiments, the controller 30 is programmed to execute a control program to control the electric motor 28 according to the information from sensors and commands resulting from operations performed by the user.

In an assist mode, in certain embodiments, the controller 30 controls the electric motor 28 such that the electric motor 28 generates the desired assistance force. In certain embodiments, the controller 30 controls the electric motor 28 according to a plurality of modes. In certain embodiments, the controller 30 has two modes. Of course, the controller 30 is not limited to having two modes and can have additional modes.

In a first mode, the electric motor 28 generates a supplementary torque based on, in certain embodiments, a preprogrammed level of pedal assist. For example, during the first mode, the electric motor 28 can provide a level of assistance that the user selects from a plurality of levels (e.g., S, M, & L). In this way, the electric motor 28 can provide a level of assistance (e.g., Nm) that is fixed and independent of the user's pedaling force. For example, in certain embodiments, the level of assistance is 20 Nm regardless of the user's pedaling force. In this way, the electric motor 28 adds 20 Nm as a pedal assist to the driveline. The level of assistance can be more or less than 20 Nm.

In certain embodiments, the electric motor 28 can provide a level of assistance (e.g., Nm) that varies depending on the user's pedaling force. For example, in certain embodiments, the level of assistance is 10% of the user's pedaling force. In this way, the electric motor 28 adds 10% of the user's pedaling force to the driveline. The level of assistance can be more or less than 10%. In other embodiments, the electric motor 28 provides a level of assistance (e.g., Nm) based on a look-up table accessible by the controller 30.

In a second mode, the electric motor 28 generates a supplementary torque based on, in certain embodiments, the setting of the boost assist selector input 44 and the setting of the boost trigger 46. For example, in certain embodiments, the boost trigger 46 overrides the level of pedal assist and increases the output of the electric motor 28 from the pedal assist level to the boost assist level.

In certain embodiments, during the second mode, the electric motor 28 provides a level of assistance than can be fixed or vary relative to the information from the sensors and commands resulting from operations performed by the user. In certain embodiments, the electric motor 28 can provide a level of assistance (e.g., Nm) that is fixed and independent of the user's pedaling force. For example, in certain embodiments, the level of boost assistance is 50 Nm regardless of the user's pedaling force. In this way, the electric motor 28 adds a total of 50 Nm to the driveline. The level of boost assistance can be more or less than 50 Nm. Continuing with the example above where the electric motor 28 adds 20 Nm during the first mode of pedal assist, the electric motor adds an addition 30 Nm when in the second mode of boost assist for a total level of assistance of 50 Nm. Effectively, the electric motor 28 adds a total of 50 Nm when in the second mode.

In certain embodiments, the electric motor 28 can provide a level of assistance (e.g., Nm) that varies depending on the user's pedaling force. For example, in certain embodiments, the level of assistance is 30% of the user's pedaling force. In this way, the electric motor 28 adds 30% of the user's pedaling force to the driveline. The level of assistance can be more or less than 30%. In other embodiments, the electric motor 28 provides a level of assistance (e.g., Nm) based on a look-up table accessible by the controller 30.

In certain embodiments, the electric motor 28 adds torque during the first mode independent of the user's pedaling force and then further increases the level of assistance during the second mode based on the user's pedaling force. In certain embodiments, the electric motor 28 adds torque during the first mode based on the user's pedaling force and then further increases the level of assistance during the second mode independent of the user's pedaling force. In certain embodiments, the torque applied during the second mode is stacked on the torque applied during the first mode.

In both modes, the controller 30 controls the electric motor 28. In the illustrated embodiment, the electric motor 28 is attached to the down tube. In other embodiments, the electric motor 28 is disposed on other parts of the bicycle 10. For example, in certain embodiments, the electric motor 28 is disposed on, for example, the seat tube, a front sprocket 66, the chain 20, or the rear wheel 18. In the illustrated embodiment, the supplementary torque of the electric motor 28 is transmitted to the crank 22 via, for example, one or more gears of the motor 28 (not shown).

FIGS. 14A, 14B, 15A, and 15B are perspective views of a remote battery system worn by the user and housing a rechargeable battery for powering, for example, the electric motor 28. In certain embodiments, the remote battery system includes a backpack 64 and a wire or lanyard 68 for electrically connecting the bicycle 10 to the rechargeable battery in the backpack 64. The backpack 64 houses the rechargeable battery (not shown) for powering the electric motor 28. The backpack 64 can be worn by the user. In certain embodiments, the rechargeable battery (not shown) is removably installed in the backpack 64. In certain embodiments, the rechargeable battery (not shown) serves as a power source for the electric motor 28, the controller 30, and other parts that require operational electric power. In certain embodiments, the rechargeable battery (not shown) is a storage battery that uses, for example, a nickel chloride cell, a lithium-ion polymer cell, or a lithium-ion cell.

In certain embodiments, the rechargeable battery (not shown) electrically connects to the bicycle 10 via a wire or lanyard 68. The wire or lanyard 68 can include a quick disconnect 70 which disconnects the rechargeable battery (not shown) from the bicycle 10 when the backpack 64 is separated from the bicycle 10 such as when the user is unexpectedly ejected from the bicycle 10. The user can then re-connect the wire or lanyard 68 to the bicycle 10 and continue their ride. Locating the rechargeable battery (not shown) in a pack worn by the user instead of on the bicycle 10 may advantageously improve the user's ability to control the bicycle 10 by decreasing the weight of the bicycle 10.

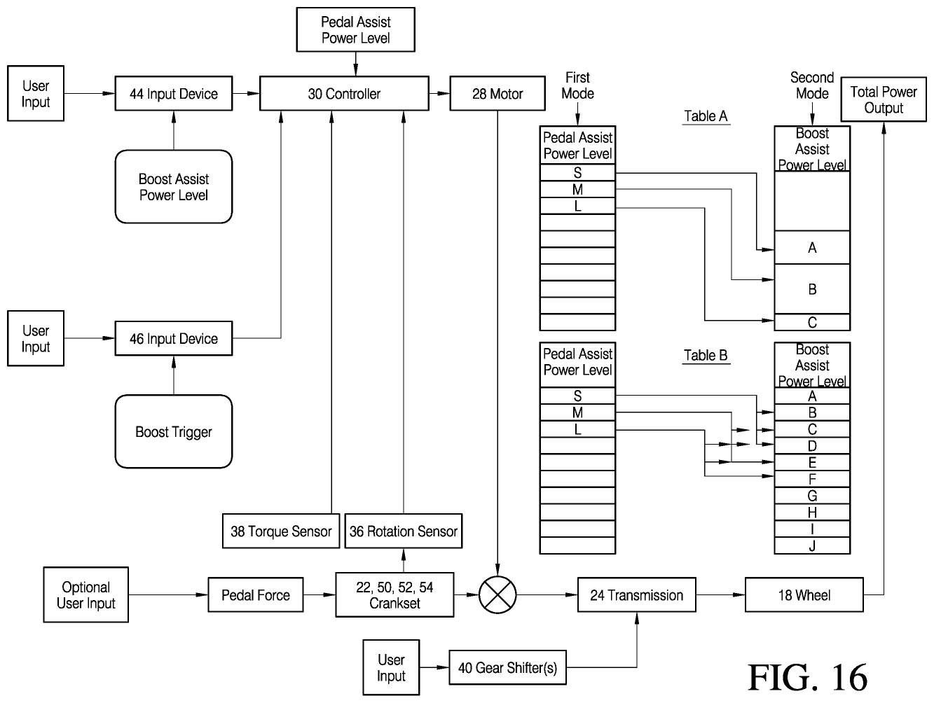

FIG. 16 is a schematic view of the bicycle control apparatus in accordance with a preferred embodiment of the present invention. In certain embodiments, the controller 30 executes a program according to the schematic shown in FIG. 16 to change the assist level provided by the electric motor 28 with respect to the information from the sensors and commands resulting from operations performed by the user.

For example, in certain embodiments, the left columns of Tables A and B represent a first mode where the electric motor 28 generates a pedal assist torque based on a preprogrammed pedal assist level. In certain embodiments, the electric motor 28 generates the pedal assist torque based on one or both of the user's pedaling force as sensed by the torque sensor (not shown). As explained above, during the first mode in certain embodiments, the electric motor 28 provides a level of assistance than can be fixed or vary relative to the information from the sensors and commands resulting from operations performed by the user. For example, the controller 30 can control the electric motor 28 to provide a constant level of pedal assist torque regardless of the torque applied by the user. In other embodiments, the controller 30 can control the electric motor 28 to provide a level of pedal assist torque that varies depending on, for example, the torque applied by the user. For example, the pedal assist torque can be determined based on a predetermined mathematical relationship with the torque applied by the user.

In a second mode as represented by the right columns in Tables A and B, the electric motor 28 generates a boost assist torque based on, in certain embodiments, one or more of the setting of the boost assist selector input 44 and the setting or activation of the boost trigger 46. During the second mode, the electric motor 28 provides a level of boost assistance than can be fixed or vary relative to the information from the sensors and commands resulting from operations performed by the user. For example, the controller 30 can control the electric motor 28 to provide a fixed boost torque amount. In other embodiments, the controller 30 can control the electric motor 28 to provide a boost torque amount that varies depending on the amount of the pedal assist torque applied during the first mode. For example, the boost torque amount can be determined based on a predetermined mathematical relationship with the pedal assist torque.

Referring to exemplary Table A in the first mode, the user preprograms or selects a pedal assist power of, for example, level S. In certain embodiments, level S provides a constant pedal assist torque depending on the implementation. During the second mode, the user selects a boost of, for example, level A via the boost assist selector input 44 and activates level A using the boost trigger 46. Level A can correspond to a position of the boost assist selector input 44. In certain embodiments, level A can provide a constant boost torque, depending on the implementation, which is greater than the pedal assist torque determined during the first mode. In this way, the boost assist power level during the second mode is level A.

Referring to exemplary Table B in the first mode, the user preprograms or selects a pedal assist power of, for example, level L. Level L provides a constant pedal assist torque depending on the implementation. During the second mode, the user can select a boost level of, for example, levels D-F via the boost assist selector input 44 and activate the desired level by modulating the position of the boost trigger 46 relative to its full range of travel. In this way, the boost torque can vary based on the position of the boost trigger 46.

In certain implementations, the boost assist power level during the second mode is determined by combining the torque levels determined during the first mode with a torque assist level associated with the boost assist level. In other implementations, the boost assist power level during the second mode is not a combination of the torque level determined during the first mode with the torque assist level associated with the boost assist level. For example, the boost assist power level during the second mode could be determined by a predetermined mathematical relationship relative to the user's pedal force independent of the supplementary torque applied during the first mode.

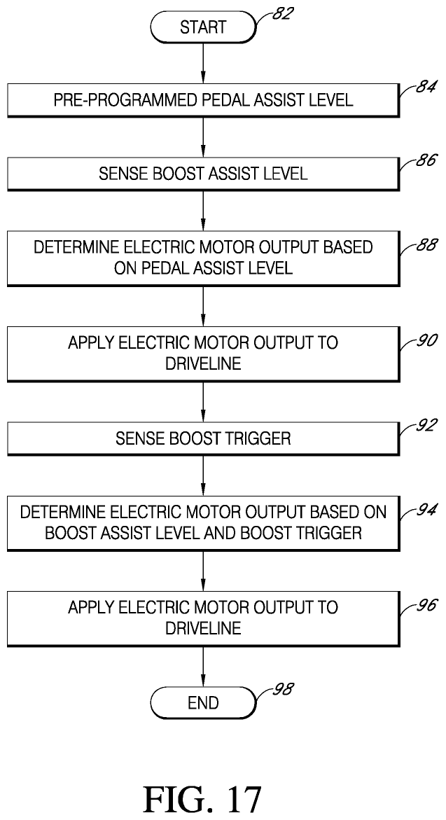

FIG. 17 is a flowchart 80 showing exemplary control operations executed by the controller 30 for controlling the electric motor 28. In certain embodiments, the controller 30 executes control according to the flowchart shown in FIG. 17 to change the pedal assist level to a boost assist power level provided by the electric motor 28 with respect to the information from the sensors and commands resulting from operations performed by the user.

The process begins at block 82. Next, the process moves to block 84 where the electric motor 28 provides a pre-programmed pedal assist level. In other embodiments, the pedal assist power level is determined at least in part by the pedal force being applied by the user. The process then moves to block 86 where the controller 30 senses the boost assist level selected by the user. The process moves to block 88 where the controller 30 determines the electric motor output based on the pedal assist power level. The process moves to block 90 where the electric motor 28 applies the output specified by the controller 30 to the driveline of the bicycle 10 during a first mode.

Next, the process moves to block 92 where the controller receives a boost trigger. The process moves to block 94 where the controller 30 determines the electric motor output based on the boost assist selector input 44 and the boost trigger 46. The process moves to block 96 where the electric motor 28 applies the output specified by the controller 30 to the driveline of the bicycle 10 during a second mode. The process ends at block 98.

While the above detailed description has shown, described, and pointed out novel features of the development as applied to various embodiments, it will be understood that various omissions, substitutions, and changes in the form and details of the devices illustrated may be made by those skilled in the art without departing from the spirit of the development. As will be recognized, the present development may be embodied within a form that does not provide all of the features and benefits set forth herein, as some features may be used or practiced separately from others. All changes which come within the meaning and range of equivalency of the claims are to be embraced within their scope.

The foregoing description details certain embodiments of the systems, devices, and methods disclosed herein. It will be appreciated, however, that no matter how detailed the foregoing appears in text, the systems, devices, and methods may be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment may be included with other depicted embodiments in any combination. For example, any of the various components described herein and/or depicted in the Figures may be combined, interchanged or excluded from other embodiments.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The term “comprising” as used herein is synonymous with “including” or “containing” and is inclusive or open-ended and does not exclude additional, unrecited elements or method steps.

The above description discloses several methods of manufacture and materials of the present development. This development is susceptible to modifications in the methods and materials, as well as alterations in the fabrication methods and equipment. Such modifications will become apparent to those skilled in the art from a consideration of this disclosure or practice of the development disclosed herein. Consequently, it is not intended that this development be limited to the specific embodiments disclosed herein, but that it covers all modifications and alternatives coming within the true scope and spirit of the development as embodied in the attached claims.

While the above detailed description has shown, described, and pointed out novel features of the improvements as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. The scope of the invention is indicated by the appended claims rather than by the foregoing description. All changes which come within the meaning and range of equivalency of the claims are to be embraced within their scope.

What is claimed is:

1. A method for controlling power supplied to an electric drive system of an electric bicycle, comprising:
determining a pedal assist power level for the electric drive system;
determining a first current to be applied to the electric drive system based on the pedal assist power level;
detecting a user selected boost assist at a first input while the first current is being applied to the electric drive system; and
determining a second current to be applied to the electric drive system based at least in part on both the user selected boost assist and a boost trigger, the boost trigger being received via a second input.

2. The method of claim 1, further comprising,
applying the first current to the electric drive system during a first period of time; and
applying the second current to the electric drive system during a second period of time.

3. The method of claim 1, wherein the first input is a lever disposed on a first end of a handlebar of the electric bicycle.

4. The method of claim 1, wherein the pedal assist power level is preprogrammed.

5. The method of claim 3, wherein the second input is a push button disposed on a second end of the handlebar.

6. The method of claim 1, wherein the user selected boost assist is a fixed amount.

7. The method of claim 1, wherein the user selected boost assist is a variable amount.

8. The method of claim 7, wherein the variable amount is based on a user selected position of the second input.

9. The method of claim 7, wherein the variable amount is based on a user selected position of the first input.

10. The method of claim 9, wherein a maximum value of the user selected boost assist is a ratio of the pedal assist power level.

11. A control system for controlling power supplied to an electric motor of an electric bicycle, comprising:
a first input configured to receive a user selected boost assist for an electric drive system;
a second input configured to receive a boost trigger for the electric drive system;
an electric motor; and
a controller configured to determine,
a first current to be applied to the electric motor based on a pedal assist power level, and
a second current to be applied to the electric motor based at least in part on both the user selected boost assist and the boost trigger.

12. The system of claim 11, wherein the electric bicycle is a mountain bike.

13. The system of claim 11, further comprising a manual drive system comprises a crankset, a chain, and at least one gear for transferring manual power mechanically from the crankset to at least one wheel of the electric bicycle.

14. The system of claim 13, wherein the electric motor is rotationally coupled to the crankset.

15. The system of claim 13, further comprising a gear shifter and a derailleur, the gear shifter controlling the derailleur to position the chain on the at least one gear.

16. The system of claim 13, further comprising pedals and a bottom bracket, the pedals being coupled to the crankset for receiving user power, the bottom bracket supporting the crankset relative to the electric motor.

17. The system of claim 11, wherein the first input is a lever actuating a first potentiometer.

18. The system of claim 17, wherein the second input is a push button actuating a second potentiometer.

19. The system of claim 11, wherein the pedal assist power level is preprogrammed.

20. The system of claim 11, wherein the first input and the second input are disposed on opposite ends of a handlebar of the electric bicycle.
